(19) United States
(12) Patent Application Publication
(10) Pub. No.: US 2010/0123930 A1
(43) Pub. Date: May 20, 2010

(54) WORKFLOW MANAGEMENT APPARATUS, AND METHOD AND PROGRAM FOR THE SAME

(75) Inventor: Hajime Tomizawa, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/619,361

(22) Filed: Nov. 16, 2009

Related U.S. Application Data
(60) Provisional application No. 61/115,224, filed on Nov. 17, 2008.
(60) Provisional application No. 61/147,291, filed on Jan. 26, 2009.

(51) Int. Cl. G06F 3/12

(52) U.S. Cl. 358/1.15

(57) ABSTRACT

A technique is provided that enables efficient determination of the executability of a workflow while considering changes in processing target data that are sequentially processed in the workflow. A workflow management apparatus includes: a processing result acquisition unit which acquires information about processed data that is processed in a processing unit of plural processing units; an execution condition acquisition unit which acquires information about an execution condition of processing in a processing unit located downstream from the processing unit for which the information about the processed data is acquired by the processing result acquisition unit; and an executability determination unit which determines whether or not the processed data with its information acquired by the processing result acquisition unit can be processed in a processing unit located downstream from the processing unit in which the processed data is processed, on the basis of the information about the execution condition acquired by the execution condition acquisition unit.

### CROSS-REFERENCE TO RELATED APPLICATION

This application is based upon and claims the benefit of priority from: U.S. provisional application 61/115,224, filed on Nov. 17, 2008; U.S. provisional application 61/147,291, filed on Jan. 26, 2009, the entire contents of each of which are incorporated herein by reference.

### TECHNICAL FIELD

The present invention relates to assistance in use of a workflow including plural activities, and particularly to a technique of determining whether a workflow is executable or not.

### BACKGROUND

Conventionally, a technique of connecting processing units called “activities” such as “printing of an image” and “saving of an image file” in an arbitrary order and thus forming a workflow to carry out a series of processes such as “printing an image and saving the image as a file” is known.

In a workflow formed as a result of combining plural activities as described above, depending on the nature of an activity forming the workflow, the activity may be inexecutable in a certain execution environment and the workflow cannot be completely executed in some cases. Thus, a configuration is known in which, at the time of starting a workflow and executing each activity, it is determined whether the activity to be executed is executable or not, and if there is an inexecutable activity, the user is notified of information that the complete execution of the workflow is impossible (see, for example, JP-A-2004-280665).

There is also known a technique of, before starting a workflow, estimating a resource required for execution of each activity forming the workflow, then determining whether the resource is available in that execution environment or not, and thus determining whether the workflow can be completely executed or not (see, for example, JP-A-2004-289501).

Moreover, with respect to a workflow that is already started but then suspended because there is an inexecutable activity after processing of the workflow is carried out to a halfway part, a technique of editing the configuration of the workflow so that the workflow can be completely executed and then resuming the edited workflow at the halfway part is known (see, for example, JP-A-2007-115040). In this technique, data handled in the workflow are stored in a state of being processed to the halfway part. As the stored data is used again, processing is resumed at the halfway part of the workflow.

However, in the conventional technique of determining whether an activity is executable or not (JP-A-2004-280665), the executability is determined only in the stage of executing activities forming the workflow. Therefore, if this conventional technique is applied to a case where it can be determined in advance that a workflow cannot be completely executed, the execution of activities may become useless.

In the configuration where it is determined at the time of starting a workflow whether the workflow can be completely executed or not (JP-A-2004-289501), in some cases, it cannot be determined whether there is a sufficient resource available in the execution environment of the workflow until the workflow is actually executed.

Meanwhile, in the configuration where a suspended workflow is edited and made re-executable (JP-A-2007-115040), only the data of the processing result of the activity that is executed last in the suspended workflow is stored. Therefore, if processing is resumed with an activity that is not the last activity in the suspended workflow, the processing result of this activity is not saved and this activity needs to be executed again.

In this manner, with the conventional techniques, it is not possible to efficiently determine the executability of a workflow while considering changes in processing target data that are sequentially processed in the workflow.

### SUMMARY

It is an object of some embodiments of the invention to provide a technique that enables efficient determination of the executability of a workflow while considering changes in processing target data that are sequentially processed in the workflow.

According to an aspect of the invention, a workflow management apparatus includes: a processing result acquisition unit which, in a case of executing a workflow to sequentially process data as a processing target from an upstream processing unit toward a downstream processing unit of plural continuous processing units, acquires information about processed data that is processed in a processing unit in which processing is completely executed, of the plural processing units; an execution condition acquisition unit which acquires information about an execution condition of processing in a processing unit located downstream from the processing unit for which the information about the processed data is acquired by the processing result acquisition unit; and an executability determination unit which determines whether or not the processed data with its information acquired by the processing result acquisition unit can be processed in a processing unit located downstream from the processing unit in which the processed data is processed, on the basis of the information about the execution condition acquired by the execution condition acquisition unit.

According to another aspect of the invention, a workflow management method includes: in a case of executing a workflow to sequentially process data as a processing target from an upstream processing unit toward a downstream processing unit of plural continuous processing units, acquiring information about processed data that is processed in a processing unit in which processing is completely executed, of the plural processing units; acquiring information about an execution condition of processing in a processing unit located downstream from the processing unit for which the information about the processed data is acquired; and determining whether or not the processed data with its information acquired can be processed in a processing unit located downstream from the processing unit in which the processed data is processed, on the basis of the acquired information about the execution condition.

According to still another aspect of the invention, a workflow management program causes a computer to execute processing including: in a case of executing a workflow to sequentially process data as a processing target from an upstream processing unit toward a downstream processing unit of plural continuous processing units, acquiring information about processed data that is processed in a processing unit in which processing is completely executed, of the plural processing units; acquiring information about an execution condition of processing in a processing unit located downstream from the processing unit for which the information about the processed data is acquired; and determining whether or not the processed data with its information acquired can be processed in a processing unit located downstream from the processing unit in which the processed data is processed, on the basis of the acquired information about the execution condition.

### DESCRIPTION OF THE DRAWINGS

FIG. 1 is a functional block diagram showing a schematic configuration of a workflow management apparatus according to a first embodiment of the invention.

FIG. 2 shows devices for forming a workflow system according to the first embodiment of the invention.

FIG. 3 shows a workflow editing screen displayed on a web browser.

FIG. 4 illustrates a case of creating a “travel expense payment application” workflow by using a workflow configuration unit.

FIG. 5 shows an exemplary receipt schematically showing information stored in a workflow execution history storage unit that becomes an acquisition target of a scanned image.

FIG. 6 shows an exemplary workflow to carry out image processing, file saving and the like.

FIG. 7 illustrates workflow processing in the workflow system.

FIG. 8 is a functional block diagram showing a schematic configuration of a workflow management apparatus according to a second embodiment of the invention.

FIG. 9 shows contents of a flowchart version 2.

FIG. 10 shows contents of a flowchart version 1.

FIG. 11 is a flowchart for explaining a flow of processing in the second embodiment of the invention.

FIG. 12 schematically shows information stored in the workflow execution history storage unit.

FIG. 13 is a flowchart for explaining processing to re-execute a workflow.

FIG. 14 shows a screen displaying a list of executed workflows.

### DETAILED DESCRIPTION

Hereinafter, embodiments of the invention will be described with reference to the drawings.

### First Embodiment

First, a first embodiment of the invention will be described.

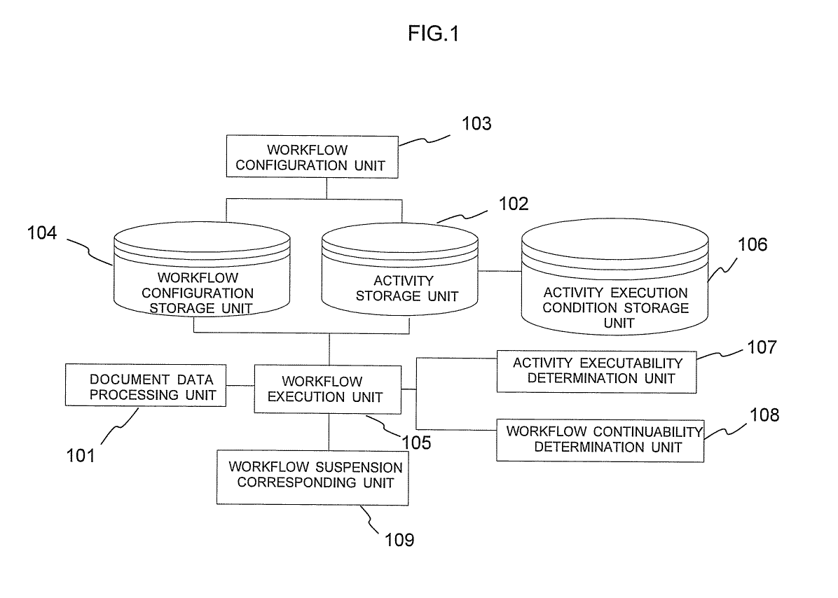

FIG. 1 is a functional block diagram showing a schematic configuration of a workflow management apparatus according to the first embodiment of the invention.

As shown in FIG. 1, the workflow management apparatus according to this embodiment has a document data processing unit 101, an activity storage unit 102, a workflow configuration unit 103, a workflow configuration storage unit 104, a workflow execution unit 105, an activity execution condition storage unit 106, an activity executability determination unit 107, a workflow continuability determination unit 108, and a workflow suspension corresponding unit 109.

The workflow management apparatus according to this embodiment carries out processing related to workflow management such as creation, editing, validation, and execution of a workflow. In this embodiment, a “workflow” refers to a series of processes as a result of combining various processes on data such as document data and image data. In this embodiment, as an example, a workflow of executing processing on document data including “scanning a paper document and acquiring a scanned image as document data,” “printing document data”, “registering document data to a file server”, and “slicing out an image from document data” will be described.

Hereinafter, components forming the workflow management apparatus according to this embodiment will be described in detail.

The document data processing unit 101 carries out a processing on document data such as scanning a paper document and acquiring document data, or printing and outputting document data.

The activity storage unit 102 stores an “activity” as a processing unit of a workflow such as “scanning a paper document” or “saving a scanned image to a file”.

The workflow in this embodiment can be configured by plural continuous activities. Data to be processing targets are sequentially processed from an upstream activity toward a downstream activity.

The workflow configuration unit 103 (editing unit) can configure a workflow as a series of processes by arraying plural activities stored in the activity storage unit 102 in order of execution and setting a desired value for an attribute of the activities. The workflow configuration unit 103 is also capable of arbitrarily editing processing contents in at least one of the plural processing units forming the configured workflow.

The workflow configuration storage unit 104 stores the execution order of the activities forming the workflow created by the workflow configuration unit 103 and the values set for the attributes of the activities.

The workflow execution unit 105 interprets the configuration of the workflow stored in the workflow configuration storage unit 104 and executes the activities in order.

The activity execution condition storage unit 106 stores, in association of each activity stored in the activity storage unit 102, an execution condition that is necessary to execute the activity.

The activity executability determination unit 107 determines whether each activity to be executed meets the execution condition stored in the activity execution condition storage unit 106 when executing the activities forming the workflow in order by the workflow execution unit 105. If the execution condition is not met (if there is a processing unit for which it is determined that processing cannot be executed) as a result of the determination, the activity executability determination unit 107 determines that the execution of the activity is impossible and instructs the workflow execution unit 105 to suspend the execution of the workflow.

The workflow continuability determination unit 108, after an activity is executed by the workflow execution unit 105, causes the activity executability determination unit 107 to determine whether all the activities to be executed after the executed activity are executable or not. The workflow continuability determination unit 108 causes the workflow to be suspended if all the activities to be executed after the executed activity are not executable.

Specifically, the workflow continuability determination unit 108 (processing result acquisition unit) acquires information about processed data processed in an activity in which processing is completely executed, of plural activities, where a workflow is executed.

Next, the workflow continuability determination unit 108 (execution condition acquisition unit) acquires information about an execution condition of processing in an activity located downstream from the activity for which the information about the processed data is acquired.

Then, the workflow continuability determination unit 108 (execution condition acquisition unit, executability determination unit) determines whether or not the processed data with its information acquired can be processed in an activity located downstream from the activity in which the processed data is processed (whether processing is continuable or not), on the basis of the information about the execution condition acquired from the activity execution condition storage unit 106.

The workflow suspension corresponding unit 109 (suspension corresponding unit) executes corresponding processing (predetermined processing) when it is determined that the activity is inexecutable by the activity executability determination unit 107 during the execution of the workflow by the workflow execution unit 105 and thus the execution of the workflow is suspended.

The workflow continuability determination unit 108 (executability determination unit) can also determine whether or not the processed data processed in a predetermined activity alone that may have influence on the execution of downstream activities, of the plural activities, can be processed in an activity located downstream from that activity.

Moreover, the workflow continuability determination unit 108 (executability determination unit) can also determine whether the processed data can be processed or not, only with respect to a predetermined activity that may be influenced by the content of the processed data with respect to the execution of processing, of activities located downstream from the activity for which the information about the processed data is acquired, of the plural activities.

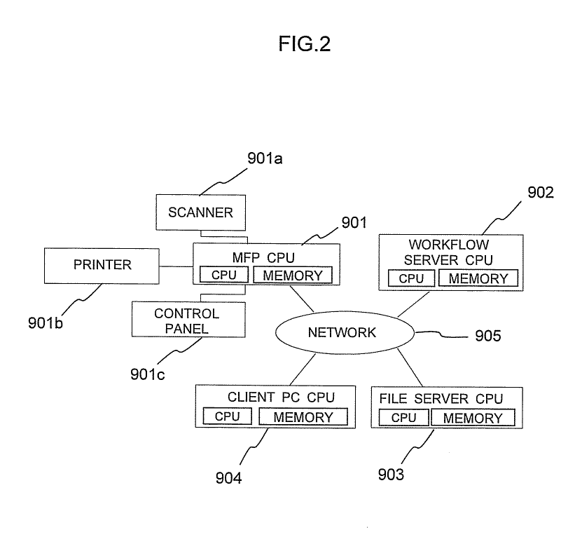

FIG. 2 shows devices constituting the workflow system 1 according to the first embodiment of the invention.

The workflow system 1 according to the first embodiment of the invention has an MFP 901, a workflow server 902, a file server 903, a client PC 904, and a network 905. Here, each of the MFP 901, the workflow server 902, the file server 903 and the client PC 904 independently has its own CPU and memory. As a program stored in the memory is executed by the CPU, a desired function in each device is realized.

The MFP 901 is a multi-function terminal device capable of handling paper documents and document data. The workflow server 902 is responsible for processing for a workflow. The file server 903 can store scanned images and so on. The client PC 904 can access the MFP 901, the workflow server 902 and the file server 903 and use a service provided from each device. The network 905 connects these devices in a wired or wireless manner to enable mutual communication of these devices.

Moreover, the MFP 901 has a scanner 901a which can scan a paper document and acquire a scanned image, a printer 901b which can print document data, and a control panel 901c which presents information to a user or accepts an operation input from the user through a touch panel display.

In the workflow system 1, the user can combine desired activities to create a workflow for executing a series of desired processes and can cause the workflow to be executed.

Each of the activities can be used in the document data processing unit 101 provided in the MFP 901 or the file server 903.

Properties can be individually set for each activity stored in the activity storage unit 102 provided in the workflow server 902. For example, information including “which document data should be registered”, “where to register” and “in what file format registration should be done” which are necessary for executing the activity of “registering document data to the file server” can be set as properties. As an execution instruction is given for the activity in the state where these properties are set, processing of each activity is executed on the basis of the information set as properties.

A workflow is defined by “configuration information” including in what order activities should be executed, and what property should be set for each activity. In a workflow, as an execution instruction is given to activities in order according to the definition content of the configuration information, a series of processes is carried out. Such configuration information of a workflow is stored in the workflow configuration storage unit 104 provided in the workflow server 902.

The workflow server 902 has the workflow configuration unit 103. The user can configure a workflow by using the workflow configuration unit 103. The operation to configure a workflow using the workflow configuration unit 103 can be carried out by using a web application provided by the workflow server 902. The user can create and edit a workflow, using a GUI screen displayed on a web browser at the client PC 904.

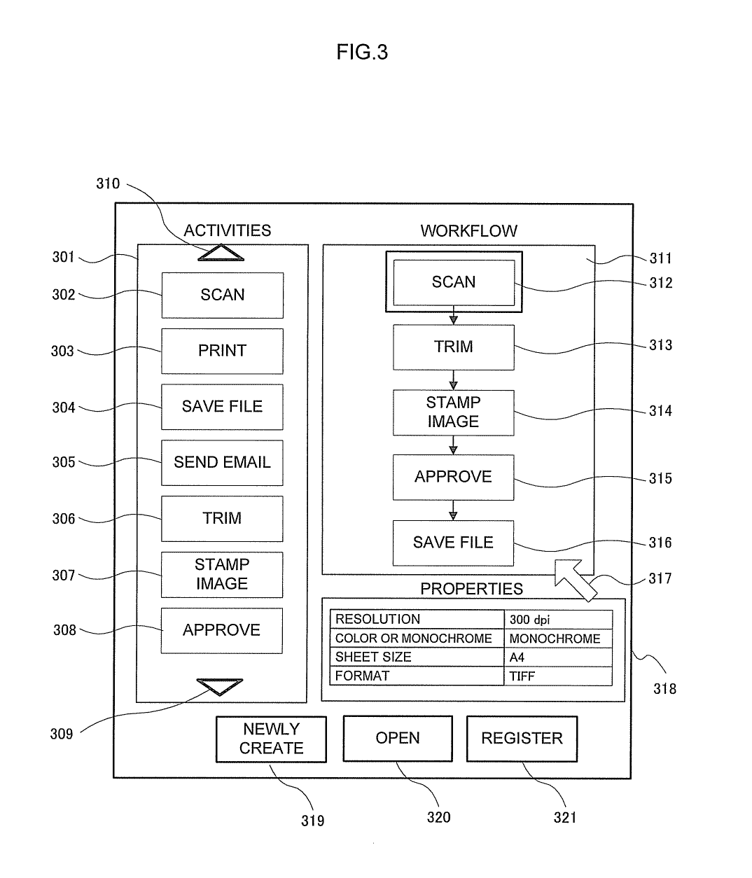

FIG. 3 shows an exemplary workflow editing screen displayed on the web browser that is shown on the screen at the client PC 904.

In FIG. 3, in an area 301 titled “activities”, activities as processing units of a workflow are displayed in the form of icons 302 to 308. The activities displayed here are stored in the activity storage unit 102 provided in the workflow server 902. These activities are shown in a list in the area 301. The user can operate a mouse pointer 317 by using a device such as a mouse. By pressing a button 309 or a button 310, the user can scroll the activity icons displayed in the area 301 or can have non-displayed icons displayed.

A workflow to be a target of editing is displayed in an area 311. Here, activities to be executed in the workflow are displayed in the form of icons 312 to 316. The connection of activities by arrows indicates the flow of processing from one activity to another. The user can add an arbitrary activity to the workflow by operating, for example, a mouse and dragging and dropping an arbitrary icon displayed in the area 301 to a position in the workflow displayed in the area 311 where the user wants to execute this activity. The user can thus edit the workflow.

The icon 312 is an icon representing a “scan” activity. Since the icon 312 shown in FIG. 3 is displayed on the screen in the state of being surrounded by a bold line, it is known that the icon 312 is selected. The user can select a desired activity by clicking an icon displayed in the area 311. When an activity is selected in this manner, the attributes of the selected activity are displayed in an area 318 titled “properties”. Here, as properties set for the currently selected “scan” activity 302, the property names “resolution”, “color or monochrome” and “sheet size”, and the values set for the respective properties are displayed in a list in the area 318.

By clicking an arbitrary line in the table displayed in the area 318, the user can edit the value of the property. The user can set and input a desired character string, using a device such as a keyboard. If the user wants to eliminate an activity selected in the area 311 from the workflow, the user can delete the activity from the workflow by pressing a delete key or the like on the keyboard.

When a workflow for carrying out desired processing is created, the user can store the created workflow to the workflow configuration storage unit 104 by clicking a “register” button 321.

In the workflow configuration storage unit 104, the execution order of the activities forming the workflow created by the workflow configuration unit 103 and set property values set for the respective activities are stored. Also, in this embodiment, when storing the workflow, the user can give the workflow a title such as “travel expense payment application”. The title thus given to the workflow is stored as information of the workflow as well. To the created workflow, a workflow ID to univocally identify the workflow is allocated and managed in the workflow configuration unit 103 or the workflow configuration storage unit 104.

If a button 319 is clicked, the area 311 is initialized and a new workflow can be created. If a workflow is created from this state and then the button 321 is clicked, the created workflow is newly registered to the workflow configuration storage unit 104.

If a button 320 is clicked, all the workflows stored in the workflow configuration storage unit 104 are displayed, for example, in the form of a list of workflow names. If the user selects a desired workflow from the displayed list, the selected workflow is displayed in the area 311 on the screen and editing of the workflow is thus enabled. After finishing the editing of the workflow, the user can update the registered content of the workflow with the edited content by clicking the button 321.

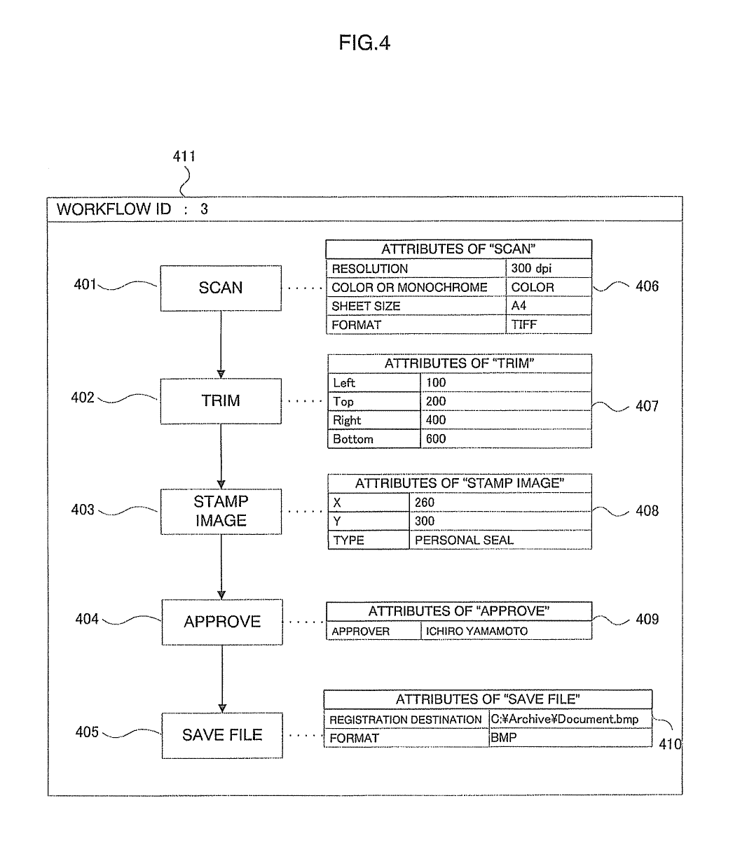

FIG. 4 illustrates a case of creating a “travel expense payment application” workflow by using the workflow configuration unit 103. Hereinafter, this “travel expense payment application” workflow will be described.

In the workflow configuration storage unit 104, configuration information about plural workflows can be stored. Each workflow is given a workflow ID that univocally identifies the workflow and the workflows can be distinguished from each other. For example, in this embodiment, “3” is set as a workflow ID 411 of the “travel expense payment application” workflow.

Next, the processing content of the “travel expense payment application” will be described in detail.

First, in a “scan” activity 401, the user acquires a scanned image as a result of digitizing a paper document by using the scanner 901a. In this case, in the “scan” activity 401, scanning is carried out with setting contents including a resolution of 300 dpi, color scan, A4 original and a file format of TIFF at the time of saving the scanned image. These setting contents are set in a properties section 406 for the “scan” activity 401.

Next, in a “trim” activity 402, the image is changed to an image acquired as result of slicing out only an area set in the properties section, from the scanned image scanned from the original. Here, a rectangular area prescribed by “Left”, “Top”, “Right” and “Bottom” set in the properties section is sliced out from the scanned image.

Next, in a “stamp image” activity 403, an image designated by a “type” property is drawn at a position designated by “X” and “Y” properties. Here, an image of the user's personal seal designated by the “type” property is drawn at a designated position in the image sliced out in the “trim” activity 402.

Next, in an “approve” activity 404, the image handled in the workflow is approved. An approval request for the image handled in the workflow (for example, a notification via email or the like) is issued to an approver designated by an “approver” property. As the approver gives approval, it is then possible for the workflow to proceed to the next process.

Meanwhile, if the approver refuses to give approval, the workflow ends at this point.

Next, in a “save file” activity 405, the image handled in the workflow is saved as a file. Specifically, the image to be a saving target is saved as a file in a file format designated by a “format” property, in a place designated by a “registration destination” property, in a properties section 410 of the “save file” activity 405. Here, the “format” property designates “BMP”, that is, saving in the bitmap format.

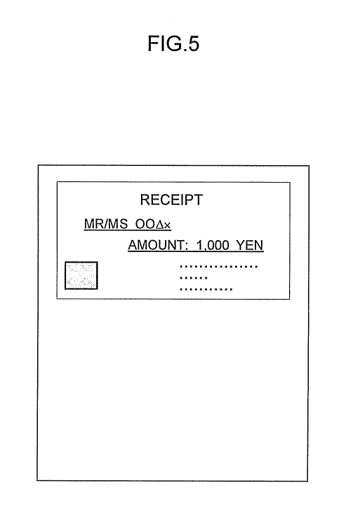

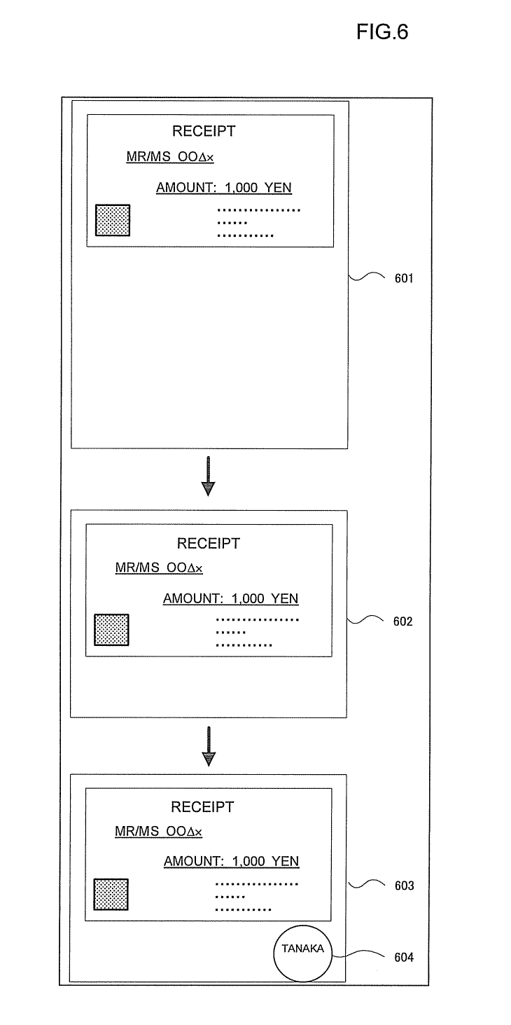

Here, a case of executing the “travel expense payment application” and acquiring a scanned image of a receipt as shown in FIG. 5 in the “scan” activity 401, which is the first activity to be executed, is described. In this case, image processing as shown in FIG. 6 is performed in the workflow and the image is saved as a file. First, when a paper document is scanned in the “scan” activity 401, image data such as an image 601 shown in FIG. 6 is acquired. Then, in the “trim” activity 402, an image formed as a result of removing a margin of the image 601 is acquired, as in an image 602. Next, in the “stamp image” activity 403, an image 603 with an image 604 of a personal seal added thereto is acquired. This image 603 is a target of approval in the “approve” activity 404. If the image is approved, the image is saved as a file in the “save file” activity 405.

Now, the activity executability determination unit 107 will be specifically described. The activity executability determination unit 107 determines whether a designated activity is executable or not. When executing this determination, the activity executability determination unit 107 refers to the execution condition of the designated activity. The execution condition is stored in the activity execution condition storage unit 106.

Specifically, in the activity execution condition storage unit 106, a condition necessary to execute each activity stored in the activity storage unit 102 is defined. For example, in the case of the “save file” activity 405, a condition is defined that “the volume of the file to be saved must be 5 Megabytes or smaller”.

The activity executability determination unit 107 refers to the execution condition stored in the activity execution condition storage unit 106 and evaluates whether the execution condition is currently met or not.

If the condition is met as a result of the evaluation, it is determined that the activity is executable. On the contrary, if the condition is not met, it is determined that the activity is inexecutable and the workflow execution unit 105 is instructed to suspend the workflow.

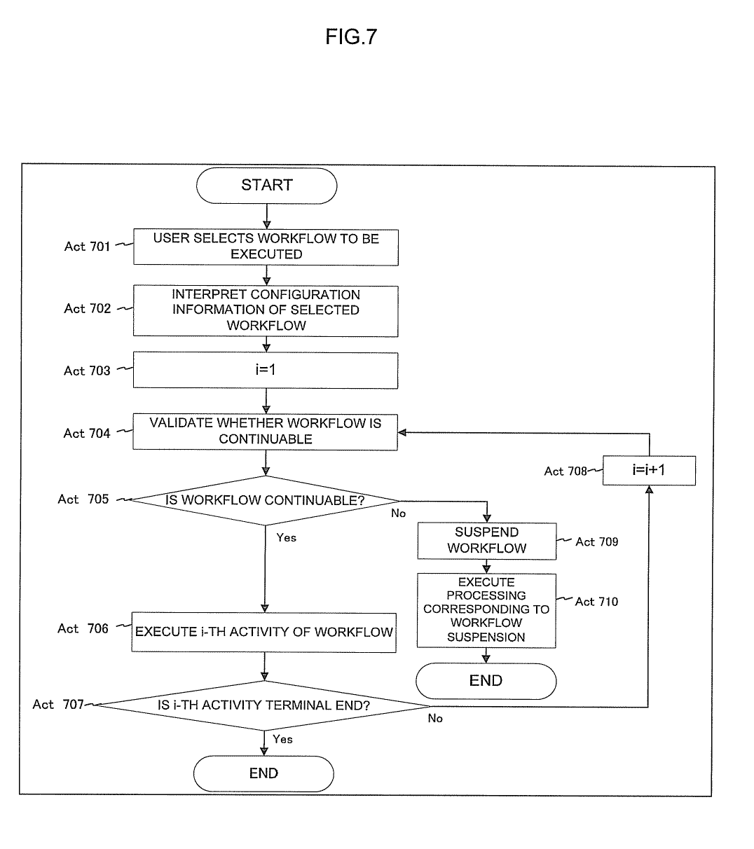

Next, the workflow processing in the workflow system 1 will be described with reference to the flowchart shown in FIG. 7.

First, in ACT 701, a list of workflows stored in the workflow configuration storage unit 104 is displayed on the screen of the control panel 901c of the MFP 901 by the workflow execution unit 105 provided in the workflow server 902. The user operates the control panel 901c and selects a workflow which the user wants to execute from the presented list of workflows. As the workflow is selected by the user, the workflow ID of the selected workflow is decided.

Next, in ACT 702, the workflow execution unit 105 acquires and interprets the configuration information of the workflow corresponding to the workflow ID decided in ACT 701, with reference to the workflow configuration storage unit 104. Thus, the execution order of activities of the selected workflow and the property set for each activity can be acquired.

Next, in ACT 703 to ACT 708, the workflow execution unit 105 executes activities of the workflow in order.

In ACT 704, the workflow continuability determination unit 108 validates whether the workflow is continuable or not. The workflow continuability determination unit 108 will be described later in detail.

If it is determined in ACT 704 that the workflow is continuable, the processing goes to ACT 706 and activities are executed. The processes of ACT 704 to ACT 708 are repeated. As the execution of all the activities in the workflow is finished, the processing of the workflow is ended.

On the other hand, if it is determined in ACT 704 that the workflow is not continuable, the processing shifts to ACT 709 and the activity executability determination unit 107 gives an instruction to suspend the workflow to the workflow execution unit 105.

In ACT 710, the workflow suspension corresponding unit 109 carries out processing corresponding to the workflow suspension. Specifically, the processing to be executed by the workflow suspension corresponding unit 109 at the time of workflow suspension may include, for example, processing to display at which point the workflow is suspended, on the control panel 901c, thus let the user learn this information, and then end the processing of the workflow.

Next, the workflow continuability determination unit 108 will be described. When executing an activity in the workflow, the workflow continuability determination unit 108 causes the activity executability determination unit 107 to determine whether activities subsequent to the activity to be executed are executable or not.

For example, in the case of executing the “approve” activity 404, which is the fourth activity in the “travel expense payment application” workflow shown in FIG. 4, the workflow executability determination unit 107 determines whether all the activities subsequent to the “approve” activity 404 are executable or not.

Here, for the “save file” activity 405, a condition is set that “the volume of the file to be saved must be 5 MB or smaller”. In the stage where the “approve” activity 404 is about to be executed, activities up to the “stamp image” activity 403 are already executed and the image 603 is already acquired.

At this point, the “save file” activity 405 subsequent to the “approve” activity 404 is to save this image 603 as a file. Therefore, if the image 603, when saved, becomes a file of 5 Megabytes or greater, the “save file” activity 405 cannot be executed. That is, even if the execution of the “approve” activity 404 is complete, the “save file” activity 405 cannot be executed and therefore this workflow cannot be completely executed.

In this manner, in this embodiment, a workflow that cannot be completely executed is suspended in the stage before executing the “approve” activity 404.

Thus, wasteful processes can be avoided, such as executing the “approve” activity 404, then attempting and failing to save an image file of 5 MB or greater that cannot be saved in the “save file” activity 405, and then suspending the workflow.

In some cases, the processing result in an activity to carry out n-th processing in the workflow does not have a nature that influences the complete execution of the entire workflow processing and is not used as an input value in a specific activity or all the activities to carry out the processing subsequent to (n+1)th processing. In such cases, in the determination by the workflow continuability determination unit 108, the determination about whether processing can be completely executed or not on the basis of the processing result in the n-th activity may be omitted.

As described above, with the configuration according to this embodiment, if it can be determined that a workflow cannot be completely executed during the execution of the workflow, the workflow can be suspended at as early a stage as possible and ended before executing inexecutable processing. Thus, the time taken for the execution of the workflow that cannot be completely executed can be reduced, and this reduction can contribute to improvement in management efficiency in the workflow management.

### Second Embodiment

Now, a second embodiment of the invention will be described. The second embodiment of the invention is a modification of the first embodiment described above. Hereinafter, in this embodiment, parts having similar functions to already described parts in the first embodiment are denoted by the same reference numerals and will not be described further in detail.

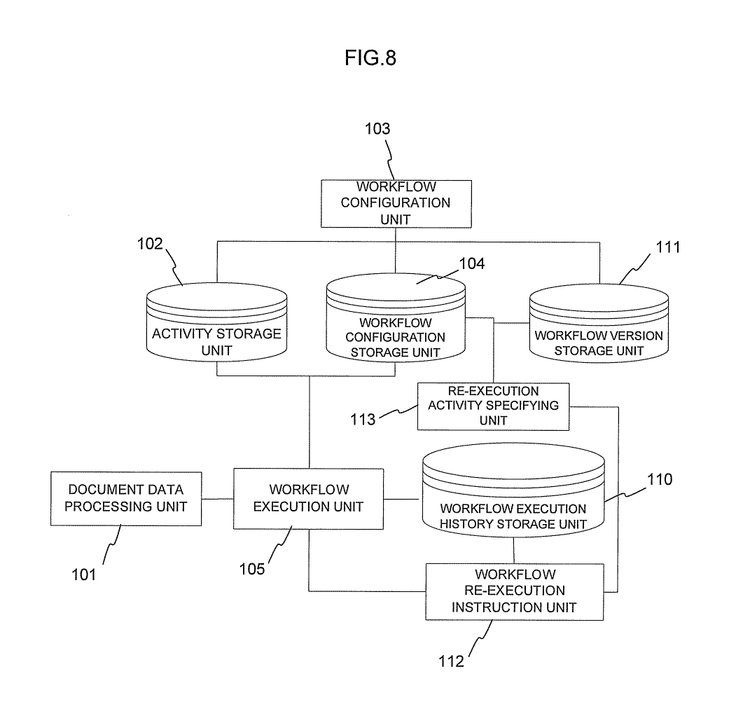

FIG. 8 is a functional block diagram for explaining the configuration of a workflow system 2 according to the second embodiment of the invention.

The workflow system 2 according to the second embodiment of the invention has a document data processing unit 101, an activity storage unit 102, a workflow configuration unit 103, a workflow configuration storage unit 104, a workflow execution unit 105, a workflow execution history storage unit 110 (processing result acquisition unit, processing result storage unit), a workflow version storage unit 111, a workflow re-execution instruction unit 112, and a re-execution activity specifying unit 113 (re-execution control unit).

Hereinafter, the workflow execution history storage unit 110, the workflow version storage unit 111, the workflow re-execution instruction unit 112, and the re-execution activity specifying unit 113, which are newly added in this embodiment, will be described in detail.

The workflow execution history storage unit 110 acquires information about execution of a workflow such as identification information of an executed workflow and start time of the workflow at the time of executing the workflow by the workflow execution unit 105, and data used as a target of processing in each activity when the workflow is executed (here, image data), and stores the acquired data in association with the executed activity.

The workflow version storage unit 111 stores the configuration of a workflow of an old version before reconfiguration, when reconfiguring the execution order and properties of activities of the workflow stored in the workflow configuration storage unit 104 by using the workflow configuration unit 103 and overwriting the workflow configuration storage unit 104 with the reconfigured workflow again.

The workflow re-execution instruction unit 112, when an arbitrary workflow is designated from workflow execution history stored in the workflow execution history storage unit 110 and then an arbitrary activity in the designated workflow is designated, acquires an image serving as a processing target in the past execution of the designated activity, from the workflow execution history storage unit 110, and gives input to the workflow execution unit 105 in order to process the acquired image in activities subsequent to the designated activity.

The re-execution activity specifying unit 113, when re-executing a workflow that is executed once and stored in the workflow execution history storage unit 110, specifies which activity the processing should be resumed with in order to avoid duplicate processing.

It is assumed that this workflow system 2 is formed by devices similar to those of the workflow system 1 (see FIG. 2) and that the functions of the system are thus realized.

In the workflow system 2, after a workflow is executed and then suspended or completed, the configuration of the executed workflow is edited by the workflow configuration unit 103 and the workflow can be re-executed. For example, there is a case where since the execution of a configured workflow is attempted but then suspended, the user wants to change the configuration of the workflow so that the workflow does not become suspended, and to re-execute the workflow. There is another case where if the user is not satisfied with the processing result according to a workflow though the workflow is successfully completed, the user wants to change the configuration and re-execute the workflow.

In such cases, when re-executing the workflow, it is not necessary to re-execute activities having no change in processing contents such as data to be a processing target in the workflow (for example, scanned image) and already approved contents. Therefore, in view of processing efficiency, it is desirable to re-execute activities of the workflow excluding activities in which perfectly the same processing as the processing before the change is executed.

In the workflow system 2, as in the above-described workflow system 1, a workflow can be configured on the operation screen as shown in FIG. 3 by using the workflow configuration unit 103.

Here, the update of a workflow will be described in detail. The user can edit a set value of a registered workflow displayed on the screen by clicking the area 318 on the workflow configuration screen. If the user clicks the button 319 after finishing the editing of the workflow, the user can overwrite and update the configuration information of the workflow stored in the workflow configuration storage unit 104 with the updated workflow configuration.

Here, in the workflow configuration storage unit 104, the version information of the stored workflow can be stored. The version number is updated when the workflow is overwritten. At the same time, the configuration information of the workflow of the old version before being overwritten is stored as history in the workflow version storage unit 111. In the workflow version storage unit 111, the version number of the workflow and the configuration of the workflow are stored as a pair.

Here, a case where the “travel expense payment application” workflow shown in FIG. 4 is stored in the workflow configuration storage unit 104 and is then updated by the workflow configuration unit 103 will be described.

In the workflow stored in the workflow configuration storage unit 104, shown in FIG. 4, the “format” property of the “save file” activity 405, which is the fifth activity, is “BMP”. Now, this “BMP” is changed to “Jpeg” and the value of the “registration destination” property is changed as well.

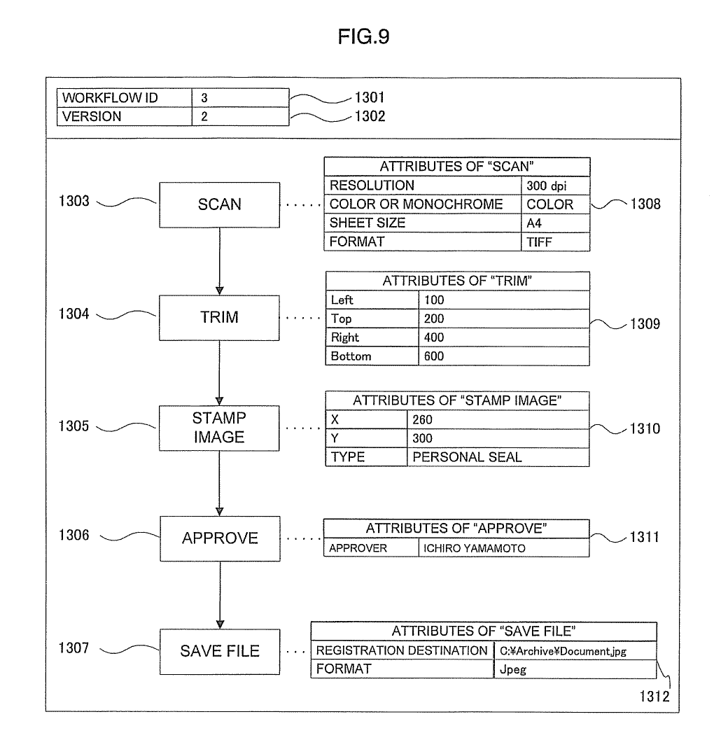

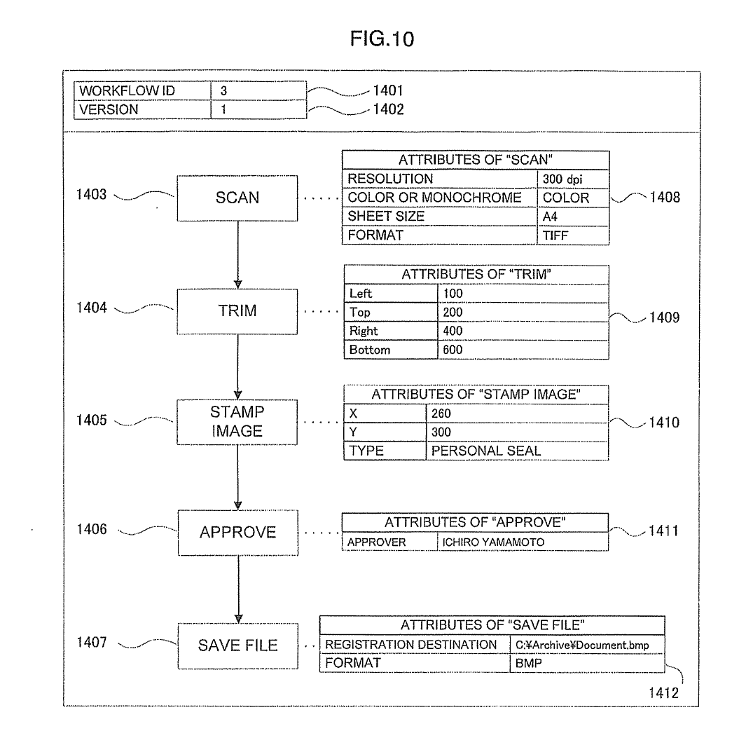

FIG. 9 shows property information of each activity of the workflow after update. FIG. 10 shows property information of each activity of the workflow before update.

The property information of the “save file” activity 405, thus updated, is stored in the workflow configuration storage unit 104. In this case, a version 1302 of the workflow is stored together with the new configuration of the workflow, as shown in FIG. 9. Here, since the update is made from the initially stored workflow, “2” is given as the version number. Meanwhile, the configuration of the workflow of the old version (version number “1”) before the update is stored in the workflow version storage unit 111. In the workflow version storage unit 111, the configuration information and a version number 1402 of the workflow before the update are stored as well, as shown in FIG. 10. In addition, a workflow ID 1401 to identify the stored workflow before the update is stored.

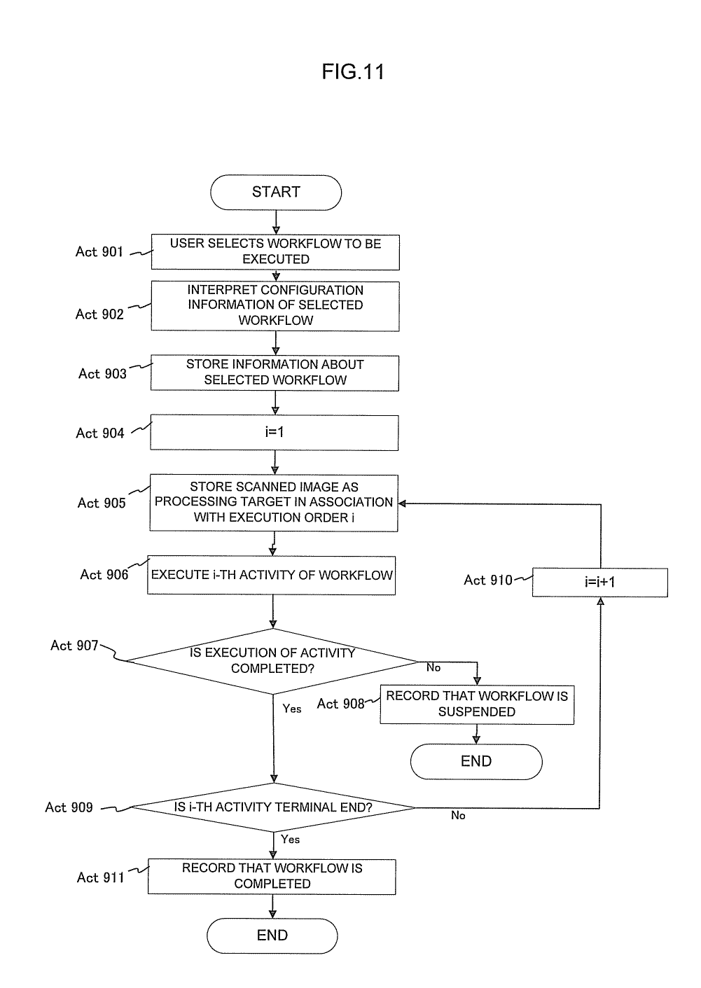

Next, a case of executing the workflow stored in the workflow configuration storage unit 104 by using the workflow execution unit 105 will be described. Hereinafter, the execution of the workflow will be described with reference to the flowchart shown in FIG. 11.

First, in ACT 901, the workflow execution unit 105 provided in the workflow server 902 presents to the user a list of workflows stored in the workflow configuration storage unit 104, on the control panel 901c of the MFP 901. The user operates the control panel 901c and selects a workflow which the user wants to execute, from the presented list of workflows. As a workflow to be executed is selected by the user's operation, the ID of the selected workflow is decided.

Next, in ACT 902, the workflow execution unit 105 refers to the workflow configuration storage unit 104 and acquires configuration information of the corresponding workflow based on the workflow ID decided in ACT 901. Thus, the execution order of activities of the selected workflow and property information set for each activity can be acquired.

Next, in ACT 903, information about the workflow to be executed, that is, workflow ID, workflow version number, workflow name and workflow start time, is stored in the workflow execution history storage unit 110. Also, the execution status of the workflow is stored in the workflow execution history storage unit 110. Here, since the workflow is started, the execution status of “in progress” is stored.

Next, in ACT 904 to ACT 910, the workflow execution unit 105 executes activities of the workflow in order.

In ACT 905, an image to become a processing target in the activity to be executed is stored in the workflow execution history storage unit 110 in association with the execution order of this activity.

After that, the activity is executed in ACT 906.

In ACT 907, it is determined whether the execution of the activity executed in ACT 906 is completed or not. If the execution is completed, the processing goes to ACT 909. If the activity cannot be executed, the processing goes to ACT 908.

If the processing goes to ACT 908, information that the workflow is suspended is stored as history information in the workflow execution history storage unit 110.

ACT 905 to ACT 910 is repeatedly executed. As the terminal end of the workflow is reached, the processing of the workflow is ended.

If the terminal end of the workflow is reached and the processing goes to ACT 911, information that the workflow is completed is stored in the workflow execution history storage unit 110.

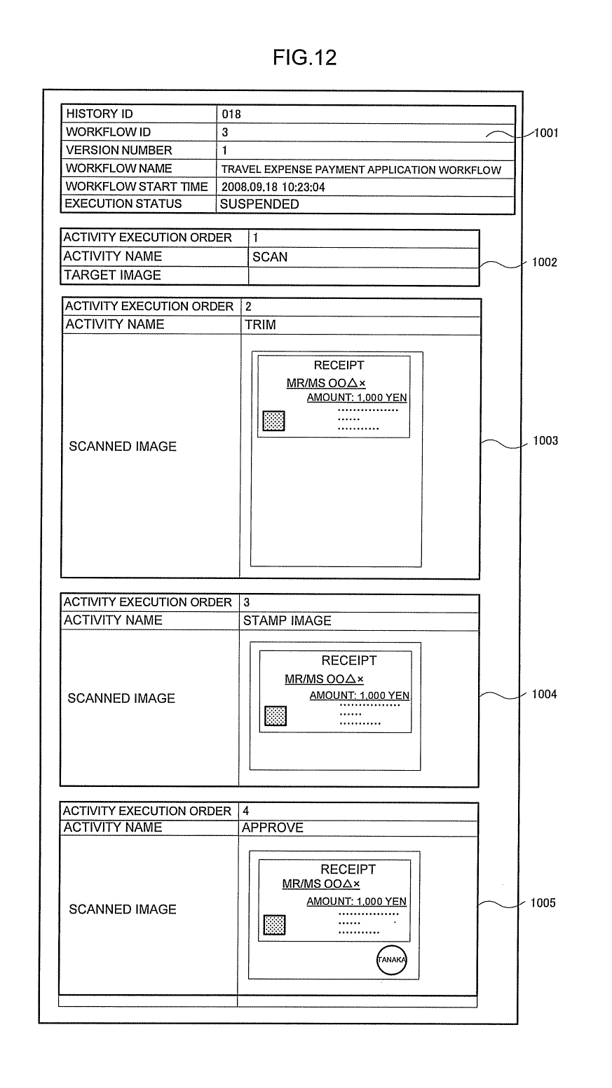

Here, a case where the “travel expense payment application” workflow shown in FIG. 4 is executed in the workflow system 2 will be described. FIG. 12 schematically shows information stored in the workflow execution history storage unit 110 in this case. A section 1001 represents information about an executed workflow, stored in ACT 903. Here, history ID, workflow ID, workflow name, workflow start time, and workflow execution status are stored.

Here, it is assumed that as the workflow is executed, the “approve” activity cannot be executed and the processing is suspended. Therefore, since the workflow cannot be completely executed, “suspended”, that is, information indicating that the workflow is suspended, is stored as the workflow execution status. The history ID is a numeric value to univocally specify the execution of the workflow and is given every time the history of the workflow is created.

Sections 1002 to 1005 show that an image to be a processing target in the activity carried out in ACT 905 is stored in association with the execution order of the activity.

The section 1002 shows that an image to be a processing target in the “scan” activity, which is the first activity to be executed in the “travel expense payment application” workflow, is stored. However, since processing on an image is not carried out in the “scan” activity, nothing is stored.

The section 1003 shows that a scanned image to be a processing target in the “trim” activity, which is the second activity to be executed, is stored.

The section 1004 shows that an image to be a processing target in the “stamp image” activity, which is the third activity to be executed, is stored. An image formed as a result of slicing out only a specified area in the second “trim” activity is a processing target in the “stamp image” activity.

The section 1005 shows that an image to be a processing target in the “approve” activity, which is the fourth activity to be executed, is stored. An image formed as a result of adding an image of a personal seal in the third “stamp image” activity is a processing target in the “approve” activity.

Here, since the “travel expense payment application” workflow is suspended before the “approve” activity is executed, execution history of the “save file” activity, which is the fifth activity to be executed, is not stored.

Next, processing in a case of updating the configuration of a workflow that is executed in the past and then re-executing the workflow will be described.

Here, it is assumed that the “travel expense payment application” workflow shown in FIG. 4 is executed but the workflow processing is suspended in the “approve” activity. It is also assumed that the “format” property in the “save file” activity is changed from “BMP” to “Jpeg”.

If the configuration of the workflow is thus updated, the workflow configuration before the update is stored in the workflow version storage unit 111 as shown in FIG. 10, and the updated workflow configuration is stored in the workflow configuration storage unit 104 as shown in FIG. 9.

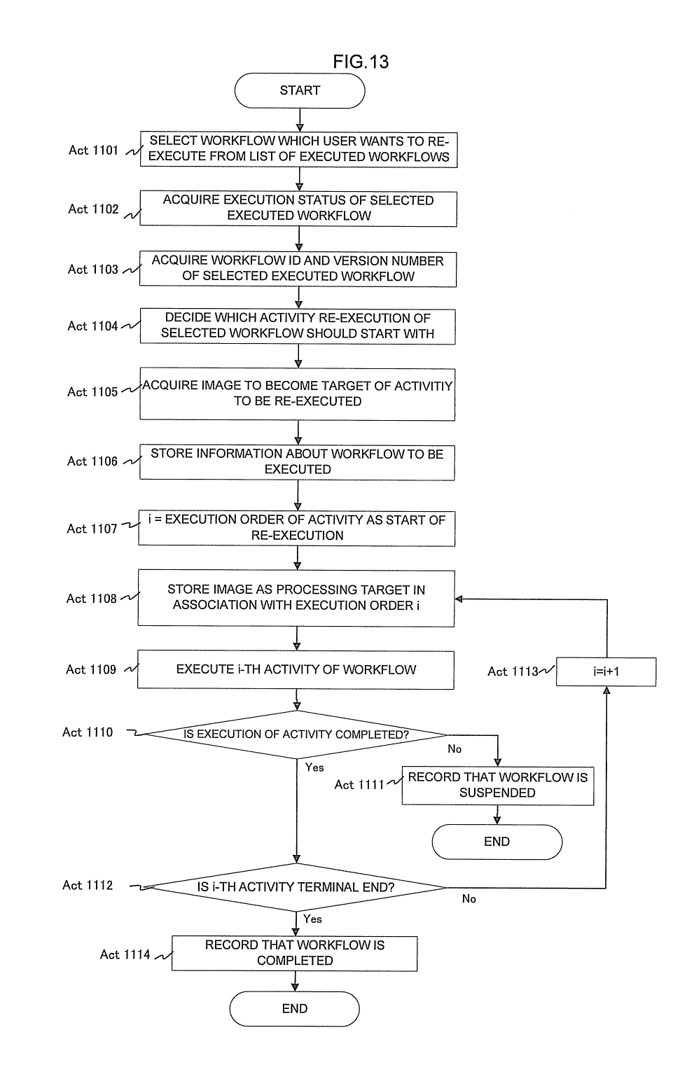

Next, processing to re-execute the workflow will be described with reference to the flowchart of FIG. 13.

First, in ACT 1101, the workflow re-execution instruction unit 112 presents to the user a list of workflows that are already executed, stored in the workflow execution history storage unit 110. The list of workflows is displayed on the screen by a web application provided by the workflow server 902. As the web application is accessed by using the client PC 904, the screen of the workflow list can be browsed. Of course, the workflow list can also be displayed on the screen of the control panel 901c.

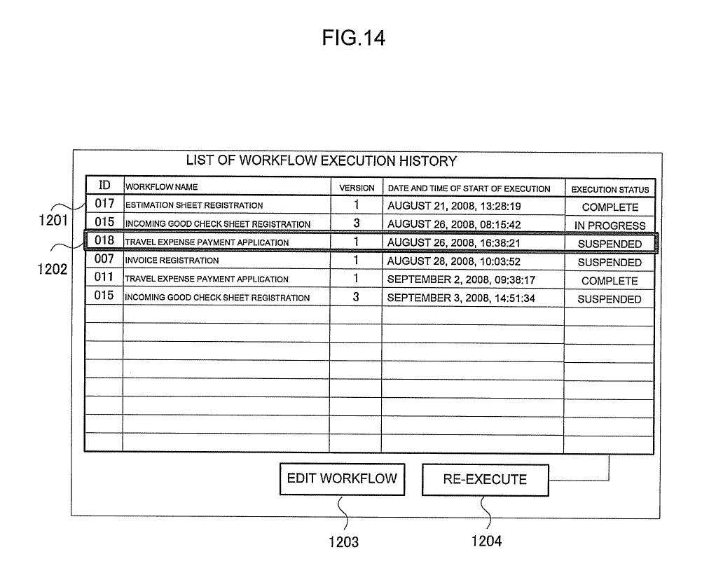

FIG. 14 shows an exemplary screen showing a list of executed workflows. A list 1201 shows a list of workflows that are already executed. Specifically, the list 1201 includes the ID, name, version, time when the workflow is executed, execution status of the workflow and so on of the executed workflows. Here, if an arbitrary line in the list 1201 is clicked, that line can be selected and the selected line is highlighted as indicated by 1202. The user selects a workflow in the list 1201 which the user wants to re-execute, and then presses a button 1204. By such operation, the user decides the workflow to be re-executed. As the workflow to be re-executed is selected by the user's operation, history ID of execution history of the selected workflow is decided. With this history ID, the execution history of the workflow corresponding to the history ID, which is stored in the workflow execution history storage unit 110, can be acquired.

If the user presses a button 1203, the user can edit the configuration of the selected workflow in the workflow editing screen shown in FIG. 3 provided by the workflow configuration unit 103.

Here, it is assumed that the “travel expense payment application” workflow having history ID “018” is selected as a workflow to be re-executed. Thus, the system can acquire the execution history of the workflow as shown in FIG. 12.

Next, the execution status of the workflow for re-execution that is selected by the user in ACT 1101 is acquired in ACT 1102. The execution status is acquired with reference to the execution history of the workflow acquired in ACT 1101.

Here, it can be seen that the execution status of this workflow is “suspended”, from the execution history of the workflow shown in FIG. 12.

Next, in ACT 1103, the history ID of the workflow is acquired, and on the basis of this history ID, the workflow ID and version number of the executed workflow corresponding to the history ID are acquired with reference to the workflow execution history storage unit 110.

Next, in ACT 1104, the re-execution activity specifying unit 113 decides which activity the execution of the workflow to be re-executed should start with. The re-execution activity specifying unit 113 specifies which activity the re-execution should start with, on the basis of the execution status and version of the executed workflow.

The re-execution activity specifying unit 113 first compares the version number of the configuration of the executed workflow stored in the workflow execution history storage unit 110 with the version number of the configuration of the workflow to be re-executed that is stored in the workflow configuration storage unit 104. If the version numbers are the same, it means that the executed workflow is executed according to the configuration of the workflow stored in the workflow configuration storage unit 104. That is, it can be understood that the executed workflow is executed according to the latest workflow configuration.

On the other hand, if the version numbers are different, it can be understood that the executed workflow is executed according to the old workflow configuration instead of the workflow configuration stored in the workflow configuration storage unit 104. That is, it can be understood that the workflow is executed according to the workflow configuration stored in the workflow version storage unit 111.

Next, the execution status of the workflow is evaluated.

A workflow having the execution status “in progress” cannot be re-executed. Therefore, processing to re-execute the workflow ends at this point.

For a workflow having the execution status “complete”, the subsequent processing differs depending on whether the executed workflow is executed according to the latest workflow configuration or executed according to the old workflow configuration.

If the workflow is executed according to the latest workflow configuration, re-execution produces the same result and therefore it can be said that re-execution is not necessary. Thus, processing to re-execute the workflow ends. Meanwhile, if the executed workflow is executed according to the old workflow configuration, re-execution of the workflow according to the latest workflow configuration may produce a different result because of the updated part of the workflow. Therefore, the workflow execution unit 105 re-executes the workflow.

In this case, since the result is the same for activities in which the property setting contents are not updated, such activities need not be re-executed. Therefore, it suffices to start re-execution with an activity that is updated from the old workflow configuration and that is to be executed first in the latest workflow. Thus, the re-execution activity specifying unit 113 decides the earliest activity in the processing order of updated activities, in the updated workflow, as the activity to start re-execution with.

For a workflow having the execution status “suspended”, it can be said that re-execution can start with an activity that is not successfully executed. Which activity is not successfully executed is determined with reference to the execution history of the workflow stored in the workflow execution history storage unit 110. In the execution history of the workflow, data to be a processing target is stored for each activity to be executed, as shown in the history information 1002 to 1005 shown in FIG. 12. Therefore, the activity stored in the end of this history is the activity that is not successfully completed in attempted execution. Therefore, the re-execution activity specifying unit 113 decides the activity that is not successfully completed, of the executed activities, as the activity to start re-execution with.

However, in the workflow the execution of which is suspended, in the case of updating the workflow configuration and then re-executing the workflow, the workflow configurations before and after update are compared and the activity to start re-execution with is decided. If the version of the workflow to be re-executed is updated from the version of the executed workflow, the earliest activity in the processing order of updated activities in the updated workflow is acquired. This earliest activity in the processing order is compared with the activity that is not successfully executed as the workflow is suspended. Then, the earliest activity in the processing order is decided as the activity to start re-execution with.

Here, it is assumed that the execution status of the workflow to be re-executed is “suspended” as shown in FIG. 14. In this case, it is considered that re-execution should start with the “approve” activity, which is not successfully executed as the workflow is suspended. Meanwhile, the version number of the workflow stored in the workflow configuration storage unit 104 shown in FIG. 9 is “2”, whereas the version number of the executed workflow stored in the workflow execution history storage unit 110 shown in FIG. 14 is “1”.

Therefore, the configuration of the executed workflow stored in the workflow version storage unit 111 shown in FIG. 10 is acquired. The configuration of the workflow to be re-executed is compared with the configuration of the executed workflow, and the earliest activity in the execution order of updated activities is specified. Here, the re-execution activity specifying unit 113 recognizes the “save file” activity, which is the fifth activity, as the activity to be re-executed.

Now, the “approve” activity, which is not successfully executed as the workflow is suspended, is compared with the updated “save file” activity. It can be determined that the earlier activity in the execution order is the “approve” activity.

Thus, activities from the first “scan” activity to the third “stamp image” activity in the workflow to be re-executed are already executed and produce perfectly the same results if re-executed. Therefore, these activities need not be re-executed. Meanwhile, the fourth “approve” activity and subsequent activities are not carried out yet and need to be re-executed. On the basis of the above, the re-execution activity specifying unit 113 decides that re-execution starts with the fourth “approve” activity.

Next, in ACT 1105, an image to be a processing target in re-execution of the workflow is acquired. An image to be a target of the activity decided as the activity to start re-execution with by the re-execution activity specifying unit 113 in ACT 1104 is acquired. Here, the scanned image information stored in the workflow execution history storage unit 110 shown in FIG. 8 is acquired. Here, re-execution is to start with the fourth “approve” activity. The image data to be a processing target at the time of executing the “approve” activity is shown as 1005 in FIG. 12. Therefore, the image data shown as 1005 is acquired and re-execution of the workflow is started with the “approve” activity using this image data as a processing target.

In this way, on the basis of the information about processed data stored in the workflow execution history storage unit 110, the re-execution activity specifying unit 113 causes the re-execution of the workflow to be started with processing of a processing unit that is downstream from the processing unit in which the processed data is processed.

Also, on the basis of the information about processed data in an activity located upstream by one from an activity having its processing content edited by the workflow configuration unit 103, the re-execution activity specifying unit 113 causes processing according to the edited activity and subsequent activities to be re-executed. Thus, in the case of executing a workflow once and then executing the workflow again that is now reconfigured by using an image that is handled in the previous execution, it is possible to avoid duplicate processing and re-execute the workflow from a halfway part.

Next, in ACT 1106, information about the workflow to be executed, that is, workflow ID, workflow version number, workflow name and workflow start time, is stored in the workflow execution history storage unit 110. The execution status of the workflow is stored in the workflow execution history storage unit 110 as well. Here, since the workflow is started, the execution status of “in progress” is stored.

Next, in ACT 1107, the activity decided by the re-execution activity specifying unit 113 in ACT 1104 is set as an activity to be a start point at the time of re-execution.

In ACT 1108 to ACT 1113, the activity decided by the re-execution activity specifying unit 113 and the subsequent activities are executed in order by the workflow execution unit 105, as in ACT 905 to ACT 910 in FIG. 11. The workflow execution unit 105 ends the processing of the workflow when the terminal end of the workflow is reached in the execution of the activities. If the terminal end of the workflow is reached and the processing goes to ACT 1114, the workflow execution history storage unit 110 stores information that the workflow is completed.

In this manner, according to this embodiment, in the case of changing the configuration of a workflow that is executed once and then re-executing the changed workflow, it is possible to simply execute activities that need re-executing, without duplicate execution of activities that are not changed even if the configuration of the workflow is updated. Thus, determination as to the executability of the workflow can be efficiently made, contributing to improvement in management efficiency.

Each operation in the above processing in the workflow management apparatus is realized as the workflow management program stored in the memory provided in each of the MFP 901, the workflow server 902, the file server 903 and the client PC 904 is executed by the CPU provided in each of these devices.

In each of the above embodiments, the exemplary configuration is described in which the functions of the workflow management apparatus are realized as a whole by causing the MFP 901, the workflow server 902, the file server 903 and the client PC 904 to collaborate. However, possible configurations are not limited to these embodiments. For example, it is possible to provide all the necessary functions as the workflow management apparatus in the MFP 901 and realize the workflow management apparatus with the MFP 901 alone. That is, it suffices that the functions as the workflow management apparatus are ultimately realized as the workflow management system as a whole. The location of each function that constitutes the workflow management apparatus is not limited to the above example.

Moreover, a program that causes a computer constituting the workflow management apparatus to execute each of the above operations can be provided as a workflow management program. In this embodiment, an exemplary case is described where the program to realize the functions embodying the invention is recorded in advance in a storage area provided inside the apparatus. However, without being limited to this example, a similar program can be downloaded to the apparatus from a network, or a similar program can be stored in a computer-readable recording medium and then installed in the apparatus. As a recording medium, any form of recording medium that can store the program and is computer-readable can be used. Specifically, the recording medium can be an internal storage device that is internally loaded in a computer such as ROM or RAM, a portable storage medium such as CD-ROM, flexible disk, DVD disk, magneto-optical disk or IC card, a database that holds a computer program, another computer or its database, or a transmission medium on a line. The functions that are installed or downloaded in this manner may be realized in cooperation with the operating system (OS) in the apparatus.

The programs in this embodiment include a program for which execution modules are dynamically generated.

The invention can be carried out in various forms without departing from the spirit and scope of the invention. Therefore, the above embodiments are simply examples in terms of all aspects and should not be interpreted as limiting the invention. The scope of the invention is defined by the attached claims and is not restricted by the texts of the specification. Moreover, all modifications and various improvements, replacements and alterations within a range equivalent to the scope of the invention fall within the scope of the invention.

As described above in detail, according to the invention, a technique can be provided that enables efficient determination of executability of a workflow while considering changes in processing target data that is sequentially processed in the workflow.

What is claimed is:

1. A workflow management apparatus comprising:
a processing result acquisition unit which, in a case of executing a workflow to sequentially process data as a processing target from an upstream processing unit toward a downstream processing unit of plural continuous processing units, acquires information about processed data that is processed in a processing unit in which processing is completely executed, of the plural processing units;
an execution condition acquisition unit which acquires information about an execution condition of processing in a processing unit located downstream from the processing unit for which the information about the processed data is acquired by the processing result acquisition unit; and
an executability determination unit which determines whether or not the processed data with its information acquired by the processing result acquisition unit can be processed in a processing unit located downstream from the processing unit in which the processed data is processed, on the basis of the information about the execution condition acquired by the execution condition acquisition unit.

2. The apparatus according to claim 1, wherein only with respect to a predetermined processing unit that may influence execution of a downstream processing unit of the plural processing units, the executability determination unit determines whether processed data processed in that processing unit can be processed in a processing unit located downstream from the processing unit or not.

3. The apparatus according to claim 1, wherein, of processing units located downstream from a processing unit for which information about processed data is acquired by the processing result acquisition unit, of the plural processing units, only with respect to a predetermined processing unit that may be influenced by a content of the processed data with respect to execution of processing, the executability determination unit determines whether the processed data can be processed or not.

4. The apparatus according to claim 1, further comprising:
a processing result storage unit which stores information acquired by the processing result acquisition unit; and
a re-execution control unit which, on the basis of the information about processed data stored in the processing result storage unit, causes re-execution of the workflow to be started with processing in a processing unit that is downstream from a processing unit where the processed data is processed.

5. The apparatus according to claim 4, further comprising an editing unit capable of editing a processing content in at least one of the plural processing units,
wherein on the basis of information about processed data in a processing unit located upstream by one from the processing unit in which the processing content is edited by the editing unit, the re-execution control unit causes processing in a processing unit subsequent to the edited processing unit to be re-executed.

6. The apparatus according to claim 1, wherein the executability determination unit causes processing of the workflow to be suspended if there is a processing unit for which it is determined that processing cannot be executed, and
the apparatus further comprises a suspension corresponding unit which executes predetermined processing if the workflow is suspended.

7. A workflow management method comprising:
in a case of executing a workflow to sequentially process data as a processing target from an upstream processing unit toward a downstream processing unit of plural continuous processing units, acquiring information about processed data that is processed in a processing unit in which processing is completely executed, of the plural processing units;
acquiring information about an execution condition of processing in a processing unit located downstream from the processing unit for which the information about the processed data is acquired; and
determining whether or not the processed data with its information acquired can be processed in a processing unit located downstream from the processing unit in which the processed data is processed, on the basis of the acquired information about the execution condition.

8. The method according to claim 7, wherein only with respect to a predetermined processing unit that may influence execution of a downstream processing unit of the plural processing units, it is determined whether processed data processed in that processing unit can be processed in a processing unit located downstream from the processing unit or not.

9. The method according to claim 7, wherein, of processing units located downstream from a processing unit for which information about processed data is acquired by the processing result acquisition unit, of the plural processing units, only with respect to a predetermined processing unit that may be influenced by a content of the processed data with respect to execution of processing, it is determined whether the processed data can be processed or not.

10. The method according to claim 7, wherein, with respect to a processing unit in which processing is completely executed, of the plural processing units, information about processed data processed in that processing unit is stored, and
on the basis of the stored information about the processed data, re-execution of the workflow is started with processing in a processing unit that is downstream from the processing unit where the processed data is processed.

11. The method according to claim 10, wherein editing of a processing content in at least one of the plural processing units is enabled, and
on the basis of information about processed data in a processing unit located upstream by one from the processing unit in which the processing content is edited, processing in a processing unit subsequent to the edited processing unit is re-executed.

12. The method according to claim 7, wherein processing of the workflow is suspended if there is a processing unit for which it is determined that processing cannot be executed, and
a predetermined processing is executed if the workflow is suspended.

13. A workflow management program causing a computer to execute processing comprising:
in a case of executing a workflow to sequentially process data as a processing target from an upstream processing unit toward a downstream processing unit of plural continuous processing units, acquiring information about processed data that is processed in a processing unit in which processing is completely executed, of the plural processing units;
acquiring information about an execution condition of processing in a processing unit located downstream from the processing unit for which the information about the processed data is acquired; and
determining whether or not the processed data with its information acquired can be processed in a processing unit located downstream from the processing unit in which the processed data is processed, on the basis of the acquired information about the execution condition.

14. The program according to claim 13, wherein the program causes the computer to execute processing in which only with respect to a predetermined processing unit that may influence execution of a downstream processing unit of the plural processing units, it is determined whether processed data processed in that processing unit can be processed in a processing unit located downstream from the processing unit or not.

15. The program according to claim 13, wherein the program causes the computer to execute processing in which, of processing units located downstream from a processing unit for which information about processed data is acquired by the processing result acquisition unit, of the plural processing units, only with respect to a predetermined processing unit that may be influenced by a content of the processed data with respect to execution of processing, it is determined whether the processed data can be processed or not.

16. The program according to claim 13, wherein the program causes the computer to execute processing in which, with respect to a processing unit in which processing is completely executed, of the plural processing units, information about processed data processed in that processing unit is stored, and
on the basis of the stored information about the processed data, re-execution of the workflow is started with processing in a processing unit that is downstream from the processing unit where the processed data is processed.

17. The program according to claim 16, wherein the program causes the computer to execute processing in which editing of a processing content in at least one of the plural processing units is enabled, and
on the basis of information about processed data in a processing unit located upstream by one from the processing unit in which the processing content is edited, processing in a processing unit subsequent to the edited processing unit is re-executed.

18. The program according to claim 13, wherein the program causes the computer to execute processing in which processing of the workflow is suspended if there is a processing unit for which it is determined that processing cannot be executed, and
a predetermined processing is executed if the workflow is suspended.
